(19) United States
(12) Patent Application Publication
(10) Pub. No.: US 2024/0271600 A1
(43) Pub. Date: Aug. 15, 2024

(54) Site Planning for Wind Turbines Using Sensor Networks

(71) Applicant: VayuAl Corp., Mill Valley, CA (US)

(72) Inventors: James Kiles, Mill Valley, CA (US); Patrick Hompe, New Canaan, CT (US); August Kiles, Mill Valley, CA (US); Gelu Vrabie, London (GB)

(21) Appl. No.: 18/438,401

(22) Filed: Feb. 10, 2024

Related U.S. Application Data
(63) Continuation of application No. PCT/US24/15287, filed on Feb. 9, 2024.
(60) Provisional application No. 63/484,192, filed on Feb. 9, 2023.

(51) Int. Cl. F03D 7/04; F03D 7/02; F03D 13/25

(52) U.S. Cl. CPC F03D 7/048; F03D 7/0204; F03D 13/25; G06F 2113/06

(57) ABSTRACT

A computer system optimizes site planning for turbines at a wind farm site, by obtaining land-based characteristics of the wind farm site, wind-based characteristics of the wind farm site, including a distribution of wind velocity and wind direction across the wind farm site over time; a number of turbines to be added; and characteristics for each of the turbines. For each turbine, the system simulates a plurality of wakes at a plurality of locations based on the wind-based characteristics and the turbine-based characteristics; determines power outputs based on the simulated wakes and aforementioned characteristics, determines successive locations of the turbine locations according by applying a gradient descent to the power outputs. The system aggregates the maximum power outputs of each turbine and displays an optimized location and final yaw angle corresponding to each turbine.

### TECHNICAL FIELD

This application relates generally to computer network technology, including but not limited to systems and methods for site planning for wind turbines using sensor networks.

### BACKGROUND

Wind farms comprise a plurality of turbines that are strategically placed to maximize power output. The amount of power that a wind turbine can produce depends on the wind characteristics at the site of the turbine and the positioning of the turbine with respect to the direction of wind flow. Thus, when optimizing power output at a wind farm, proper site planning is essential.

Meteorological evaluation towers (METs) may be used to measure the wind characteristics (speed and direction) at a potential site for a wind farm. Wind turbines may then be placed according to the classic wind turbine control strategy model (perpendicular to the wind) in locations that are selected by manual inspection of the site and the MET data.

In some instances, computational fluid dynamics (CFD) simulations may be performed on manually proposed turbine sites in order to validate the layout selection. However, such simulations are time consuming and can be infeasible for larger sites having hundreds or even thousands of potential turbine locations.

### SUMMARY

Based on the discussion above as well as other problems and disadvantages of the related art, there is a need for a wind farm site planning system that can more efficiently model large numbers of potential turbine positions across large sites. A computing device as described herein implements such a system by using gradient descent algorithms and machine learning functionality to optimize simulation efficiency and increase modeling capacity. As such, wind characteristic data can more effectively be used to optimize site selection for hundreds or even thousands of potential turbine positions across large sites encompassing, for example, as much as 25 square miles or more.

### BRIEF DESCRIPTION OF THE DRAWINGS

For a better understanding of the various described implementations, reference should be made to the Description of Implementations below, in conjunction with the following drawings in which like reference numerals refer to corresponding parts throughout the figures.

FIG. 1 is a block diagram of a wind farm site planning optimization system in accordance with some implementations.

FIG. 2 is a diagram of an example wind turbine in accordance with some implementations.

FIG. 3 is a diagram of an example wind farm site in accordance with some implementations.

FIG. 4 is a diagram of an example wind distribution in accordance with some implementations.

FIGS. 5A-5C are diagrams depicting a gradient descent algorithm being applied to proposed turbine positions at a wind farm site in accordance with some implementations.

FIG. 6 is a diagram of an off-shore wind farm site with floating turbines in accordance with some implementations.

FIGS. 7A-7B are diagrams depicting a gradient descent algorithm being applied to proposed turbine positions at an off-shore wind farm site in accordance with some implementations.

FIG. 8 is a flow diagram of a method of optimizing site planning at a wind farm site in accordance with some implementations.

### DETAILED DESCRIPTION

This disclosure describes various implementations for integrating computer network software and hardware technology with wind farm locations and potential turbine sites for the purpose of determining the most optimal location for placement of wind turbines on any permanent (onshore or offshore close to land) or temporary (floating offshore) location, including but not limited to systems and methods for site planning for wind turbines using advanced SCADA control systems to increase power production without negative impact including damage (based on advanced wind physics algorithms systems developed by scientists since 2014) using comprehensive, wireless sensor systems and networks to maximize data capture from every conceivable point and direction relative to wind and weather interactions with proposed site locations, including existing improvements and any set of planned wind turbine systems.

Notably, the implementations described herein enable comprehensive and continuous data capture related to wind composition prior to and after interaction with the site location and improvements, including the likelihood and characteristics of wind deflection impact, especially the creation and continuation of wind wake effects that diminish site power potential and increase the likelihood of costly operations and maintenance issues. Notably, the implementations described herein present the opportunity for the wind farm to measure and manage the impact of the wakes.

Stated another way, the implementations described herein take a complete systemic view of the wind, which operates best with a complete set of data with respect to what the wind is doing and where the wind is coming from. As such, this disclosure describes a wind systems approach, looking at the entire wall of motion that comes at a wind farm and goes up as high as the turbine top (e.g., 50 m above ground or above the ocean).

Various implementations of wind farm site planning optimization schemes, as described herein, simulate and optimize the layout for a number of wind turbines to be added at a wind farm site based on:
land-based characteristics of the wind farm site (e.g., location and terrain),
wind-based characteristics of the wind farm site, such as the wind distribution across the wind farm site (e.g., velocity and direction over time),
the number of wind turbines to be added to the wind farm site (e.g., in addition to pre-existing wind turbines), and
characteristics of the wind turbines to be added to the wind farm stie (e.g., model, capacity, rotor diameter, hub height).

Various implementations of site planning optimization processes, as described herein, use the aforementioned inputs to, for each wind turbine to be added:
select a position (location) for the wind turbine,
simulate wakes for the turbine at the selected position,
determine an optimal yaw angle for the turbine based on the simulated wakes at the selected position, and
determine a power output for the turbine at the selected position using the simulated wake at the optimal yaw angle.

Such site planning optimization processes may aggregate the yaw and power output results for each turbine across the wind distribution at the site, and score each turbine accordingly. In addition, such site planning optimization processes may optimize the yaw and power output scores by adjusting the locations of each turbine using a gradient descent algorithm, and repeat the aforementioned simulation and aggregation operations. Based on repeated simulations and aggregated scores, such site planning optimization processes may determine the optimal position and yaw for each wind turbine, resulting in the greatest aggregate power output across the wind farm site.

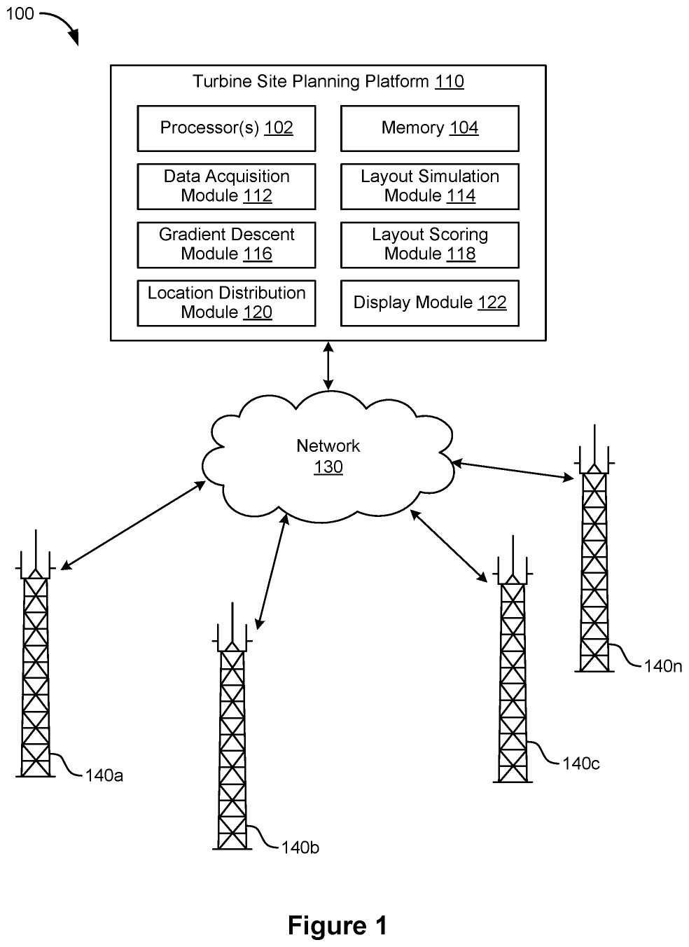

FIG. 1 is a block diagram of a wind farm site planning optimization system 100, including a turbine site planning platform 110, in accordance with some implementations. The turbine site planning platform 110 includes one or more processors 102, memory 104, and modules 112-122 governed by instructions stored in the memory. Although FIG. 1 shows various modules, FIG. 1 is intended more as a functional description of the various features which may be present in the modules than as a structural schematic of the implementations described herein. In practice, the programs, modules, and data structures shown separately could be combined, and some programs, modules, and data structures could be separated.

The processor(s) 102 include one or more central processing units (CPUs) or any other electronic circuitry configured to execute instructions comprising a computer program (e.g., the programs stored in the memory).

The memory 104 includes a non-transitory computer readable storage medium, such as volatile memory (e.g., one or more random access memory devices) and/or non-volatile memory (e.g., one or more flash memory devices, magnetic disk storage devices, optical disk storage devices, or other non-volatile solid state storage devices). The memory 104 may include one or more storage devices remotely located from the processor(s). The memory stores programs (described herein as modules and corresponding to sets of instructions) that, when executed by the processor(s) 102, cause the platform 110 to perform functions as described herein. The modules and data described herein need not be implemented as separate programs, procedures, modules, or data structures. Thus, various subsets of these modules and data may be combined or otherwise rearranged in various implementations.

The data acquisition module 112 is configured to obtain land-based data, wind-based data, and turbine-based data as described below. The data acquisition module 112 may obtain such data using any suitable input device, such as a mouse, keyboard, touchscreen, sensor input, network connection (for obtaining data from a remote source), and so forth.

The layout simulation module 114 is configured to simulate wakes and power outputs of wind turbines at proposed locations within a wind turbine site. The layout simulation module 114 performs these simulations based on the land-based data, the wind-based data, and the turbine-based data obtained from the data acquisition module 112. The layout simulation module 114 outputs optimal power outputs, locations, and yaw angles for each new wind turbine to be added to the wind turbine site.

The gradient descent module 116 is configured to adjust successive locations for each wind turbine while the layout simulation module 114 is performing successive simulations, based on application of a gradient descent algorithm to the power outputs corresponding to each wind turbine. The gradient descent module 116 determines which direction and how far each turbine should be moved for each successive simulation, in order to maximize respective power outputs for each turbine.

The layout scoring module 118 is configured to score each wind turbine based on its simulated power output during successive simulations run by the layout simulation module 114. Higher power outputs may be associated with higher scores, and the scores may be used to determine which turbine locations still need to be adjusted (e.g., based on whether an associated power output reaches a threshold).

The location distribution module 120 is configured to sample a distribution of locations about a central anchor for floating turbines at off-shore wind turbine farms. For on-shore or fixed off-shore wind farms, the location of each wind turbine is fixed, but for floating off-shore farms, the location of each wind turbine varies with respect to the anchor tethering it in place. Thus, the location distribution module 120 takes this into account and provides the layout simulation module 114 with these sampled location distributions.

The display module 122 is configured to display the turbine locations and yaw angles corresponding to the optimal power output for the wind farm site, so that site planners may design the wind farm site accordingly.

The turbine site planning platform 110 may be any electronic computing device, including one or more smartphones, tablet computers, laptop computers, smart cards, voice assistant devices, or other technology (e.g., a hardware-software combination) known or yet to be discovered that has structure and/or capabilities capable of performing the operations governed by the aforementioned modules. The platform 110 may include a communication capability (e.g., modem, transceiver, radio, and so forth) for communicating through one or more network 130.

In some implementations, system 100 may include one or more meteorological evaluation towers (METs) 140, which may be used to measure the wind characteristics (speed and direction) at a potential wind farm site.

In some implementations, the platform 110 and METs 140 may be communicatively coupled to each other by one or more communication networks 130. The communication network(s) 130 are configured to convey communications (messages, signals, transmissions, and so forth). The communications include various types of information and/or instructions including, but not limited to, data, commands, bits, symbols, voltages, currents, electromagnetic waves, magnetic fields or particles, optical fields or particles, and/or any combination thereof. The communication network(s) 130 use one or more communication protocols, such as any of Wi-Fi, Bluetooth, Bluetooth Low Energy (BLE), near-field communication (NFC), ultra-wideband (UWB), radio frequency identification (RFID), infrared wireless, induction wireless, ZigBee, Z-Wave, 6LoWPAN, Thread, 4G, 5G, and the like. Such protocols may be used to send and receive the communications using one or more transmitters, receivers, or transceivers. For example, hard-wired communications (e.g., wired serial communications) may use technology appropriate for hard-wired communications, short-range communications (e.g., Bluetooth) may use technology appropriate for close communications, and long-range communications (e.g., GSM, CDMA, Wi-Fi, wide area network (WAN), local area network (LAN), or the like) may use technology appropriate for remote communications over a distance (e.g., over the Internet). In general, the communication network(s) 130 may include or otherwise use any wired or wireless communication technology that is known or yet to be discovered.

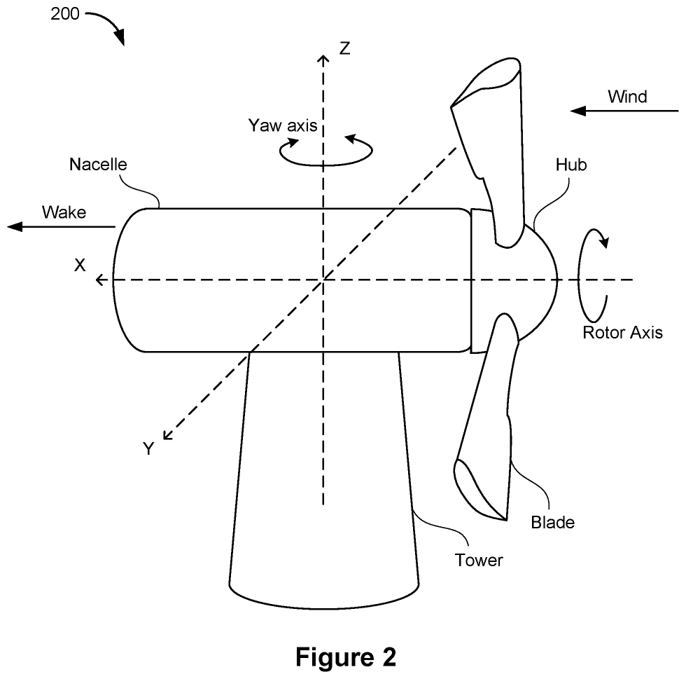

FIG. 2 is a diagram of an example wind turbine 200 in accordance with some implementations. The wind turbine 200 includes a plurality of blades affixed to a hub that rotates about a rotor axis. A nacelle houses the rotor and energy equipment for the turbine and controls a yaw angle of the blades by rotating the hub about a yaw axis traveling up and down through the tower. The optimal yaw angle positions the blades perpendicular to the direction of wind flow in order to maximize the power output of the turbine.

The spinning of the blades creates a wake behind the turbine. The wake may interfere with the speed and direction of wind that reaches a neighboring turbine, thereby disrupting the power output for the other turbine. Thus, in some implementations, wake steering may be implemented. Wake steering optimizes the locations and yaw angles of each turbine such that the negative effect of wakes on power output is minimized.

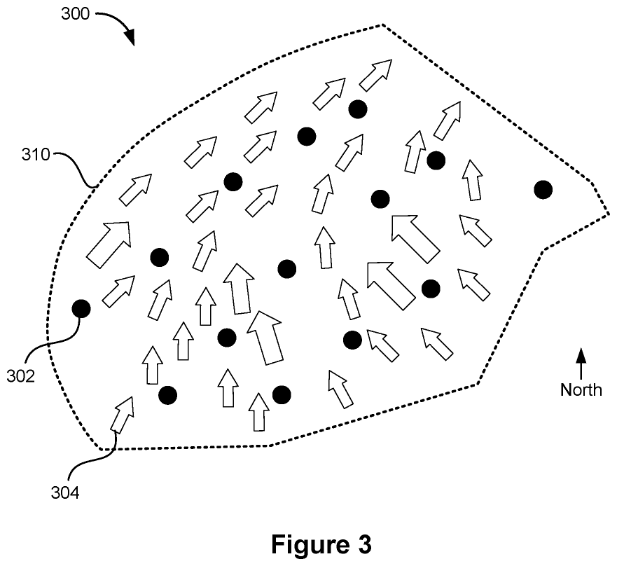

FIG. 3 is a diagram of an example wind farm site 300 in accordance with some implementations. Site 300 may be the site of an existing wind farm with existing turbines, or it may be a proposed wind farm site with no existing wind turbines. Site 300 is defined by a border 310, and includes turbine locations 302 (corresponding to existing turbines and/or proposed new turbines). A wind distribution 304 characterizes the speed and direction of wind throughout site 300.

The wind distribution 304 may be obtained by one or more METs (e.g., 140, FIG. 1), or any other sensor(s) suitable to measure the speed and direction of wind. The wind distribution 304 represents the speed and direction of wind over time. The time period may be for one or more years. While longer time periods may provide more useful wind distribution data, shorter time periods may provide more quickly accessible wind distribution data.

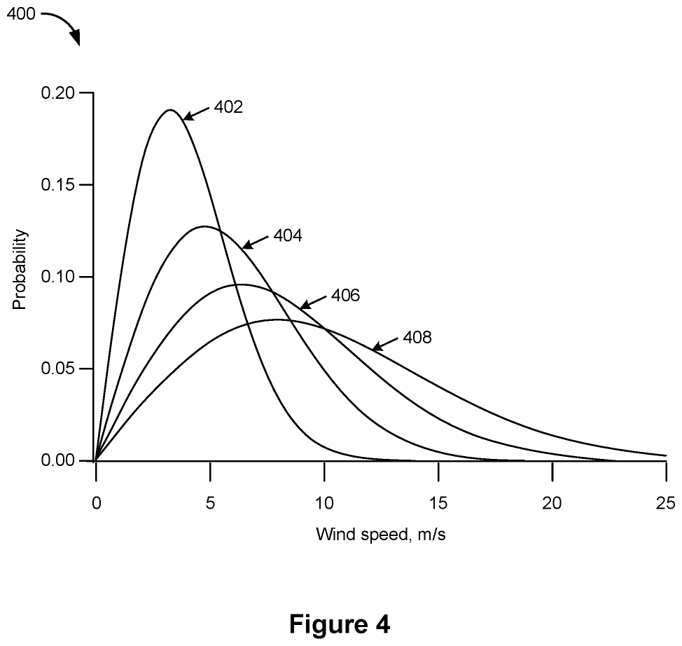

FIG. 4 is a diagram of an example wind distribution 400 in accordance with some implementations. Each wind turbine and location combination in a given wind farm (e.g., turbine 200 at location 302 in wind farm site 300) provides a unique wind distribution 400, which depends on characteristics of the turbine itself as well as measured wind speed and direction over time. In addition, different yaw angles at the same location yield different wind distribution curves. For example, four different yaw angles at the same location may respectively yield distribution curves 402, 404, 406, and 508.

In some implementations, the wind distributions may vary based on a time of year. Further, the wind distributions may vary based on how close the turbine is to the wake of a neighboring turbine. Thus, modeling performance decreases as the number of potential turbine locations in a wind farm site increases. As a result, existing wind distribution models may be limited in their scope. On the other hand, the modeling and simulation techniques described herein use gradient descent algorithms and machine learning to approximate the wind distributions across the entire wind farm site in a way that optimizes accuracy with efficiency.

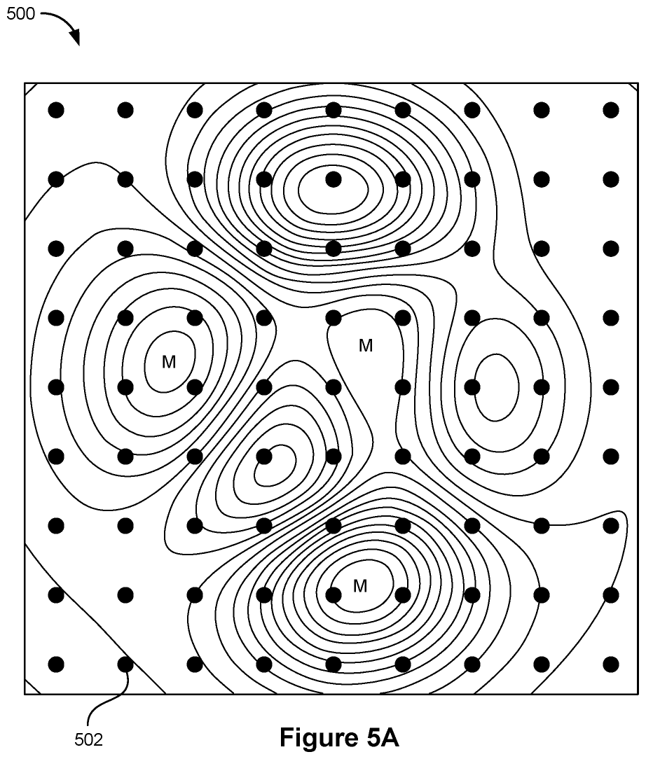

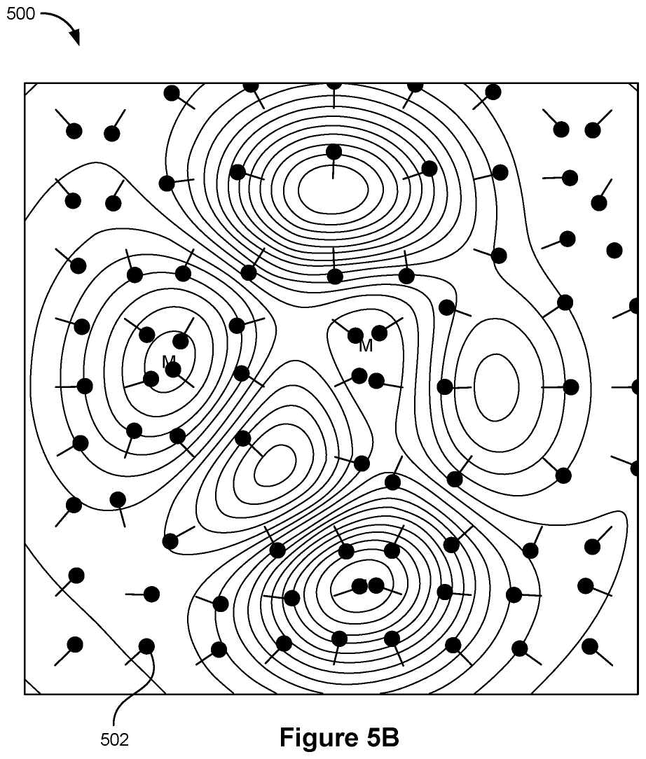

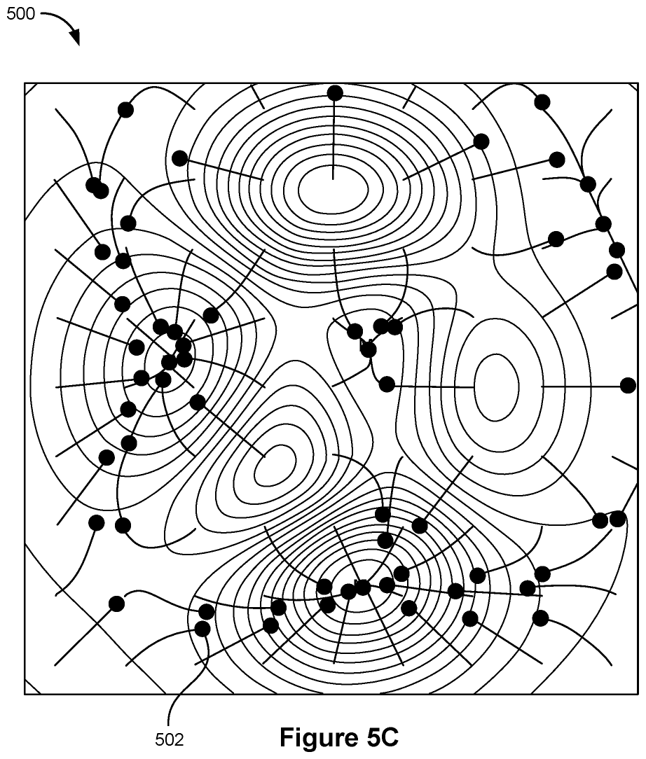

FIGS. 5A-5C are diagrams 500 depicting a gradient descent algorithm being applied to proposed turbine positions at a wind farm site in accordance with some implementations. Diagrams 500 depict a gradient of wind speeds and directions of flow, with local maxima M corresponding to locations with the higher wind speed and, thus, the greatest power output for turbines in those locations.

An initial turbine layout is depicted in FIG. 5A. The initial turbine layout may include manually selected locations based on terrain and wind characteristics provided by METs. Alternatively, the initial turbine layout may be automatically selected by simulation module 114 based on the terrain and/or wind characteristics. Simulation module 114 may run one or more simulations using the locations 502 of the initial layout and the wind characteristics in order to simulate wakes and determine power outputs and yaw angles for the turbines at each location.

Based on the results of the initial simulation(s), the turbine locations 502 are adjusted along the wind gradients towards the local maxima M using a gradient descent algorithm, as shown in FIG. 5B. Specifically, the wind gradients may be characterized as multi-variable functions, which are defined and differentiable at each location 502. Thus, applying a gradient descent algorithm at each location 502 causes the locations 502 to move in the direction of the fastest changes in the gradients.

Based on the results of successive simulations, the turbine locations 502 continue to be adjusted along the wind gradients towards the local maxima M using the gradient descent algorithm, as shown in FIG. 5C. After each simulation is wrong, turbine locations 502 are scored by their corresponding power outputs, and based on the scores, the locations may continue to be adjusted or they may remain where they are. For example, a high scoring location (e.g., above a predetermined threshold) may no longer need to be adjusted in future simulations, especially if such an adjustment would cause wake interference or cause two turbines to be too close to each other.

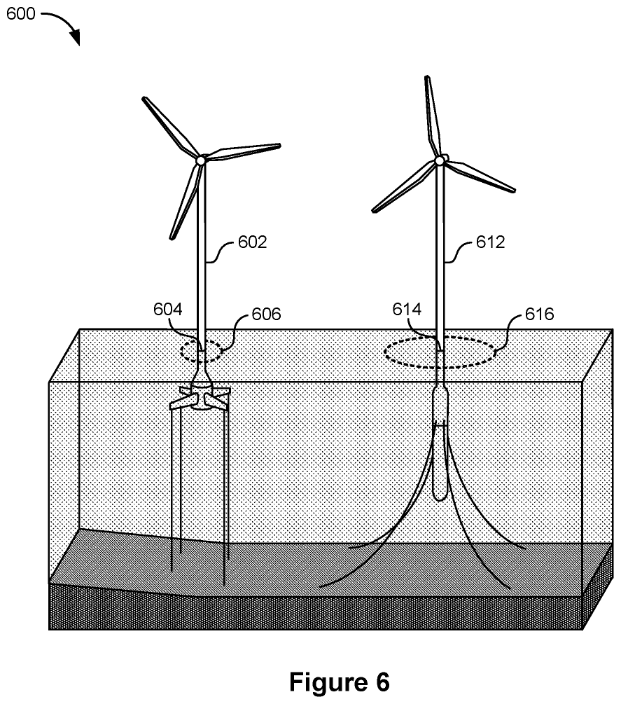

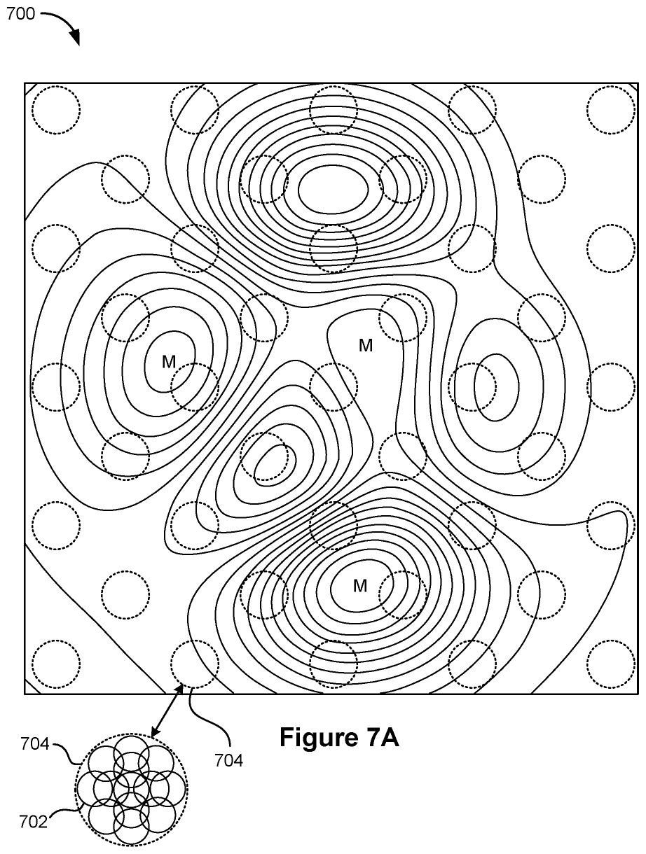

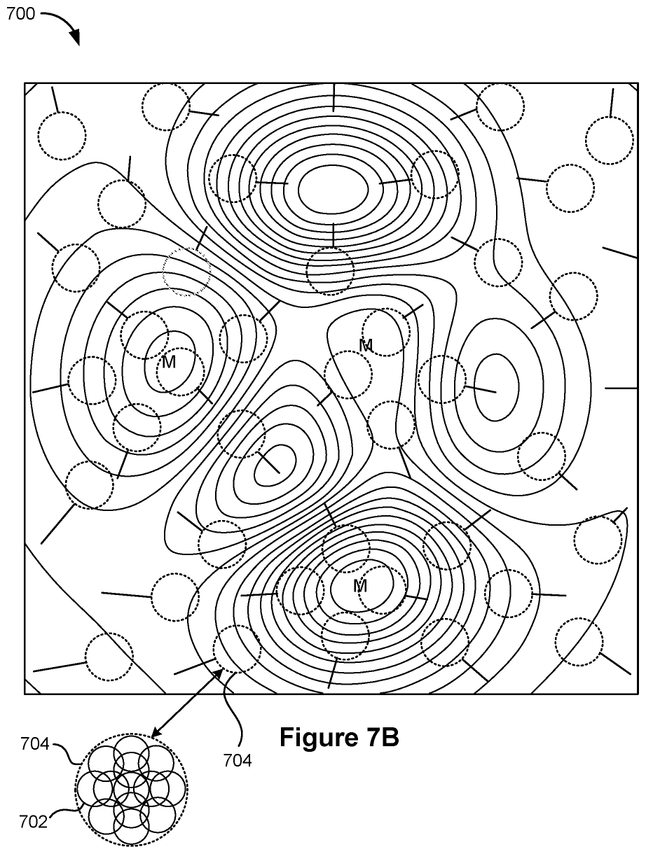

FIG. 6 is a diagram of an off-shore wind farm site 600 with floating turbines in accordance with some implementations. The main difference between an on-shore or fixed off-shore wind farm (e.g., FIGS. 5A-5C) and a floating wind farm (e.g., FIGS. 6-7B) is that the turbines in a floating wind farm do not have fixed positions. For example, in site 600, two floating turbines 602 and 612 are each anchored to the seabed. As a result of the anchoring, movement of the turbines is partially, but not fully, restricted. Specifically, the turbines may still move in an area (606, 616) about a central anchor location (604, 614).

Simulation module 114 and location distribution module 120 can account for this movement by considering the anchoring point of a turbine (604, 614) as its central location, and then sampling from a distribution of turbine locations centered at that central anchor location (areas 606, 616) when running the simulation. This allows for site planning under uncertainty, while still optimizing for location, yaw angle, and wake steering.

FIGS. 7A-7B are diagrams 700 depicting a gradient descent algorithm being applied to proposed turbine positions at an off-shore wind farm site in accordance with some implementations. Diagrams 700 correspond to diagrams 500 (FIGS. 5A-5B), except instead of considering and adjusting fixed locations 502, the simulations and gradient descent algorithms sample a distribution of locations 702 within an area 704 defined by movement around a central anchor location as described above.

An initial turbine layout is depicted in FIG. 7A. The initial turbine layout may include manually selected location distributions 704 based on wind characteristics provided by METs. Alternatively, the initial turbine layout may be automatically selected by simulation module 114 based on the wind characteristics. Simulation module 114 may run one or more simulations using the location distributions 704 of the initial layout and the wind characteristics in order to simulate wakes and determine power outputs and yaw angles for the turbines at each location.

Based on the results of successive simulations, the turbine location distributions 704 continue to be adjusted along the wind gradients towards the local maxima M using the gradient descent algorithm, as shown in FIG. 7BC. After each simulation is wrong, turbine location distributions 704 are scored by their corresponding power outputs, and based on the scores, the locations may continue to be adjusted or they may remain where they are. For example, a high scoring location distribution (e.g., above a predetermined threshold) may no longer need to be adjusted in future simulations, especially if such an adjustment would cause wake interference or cause two turbines to be too close to each other.

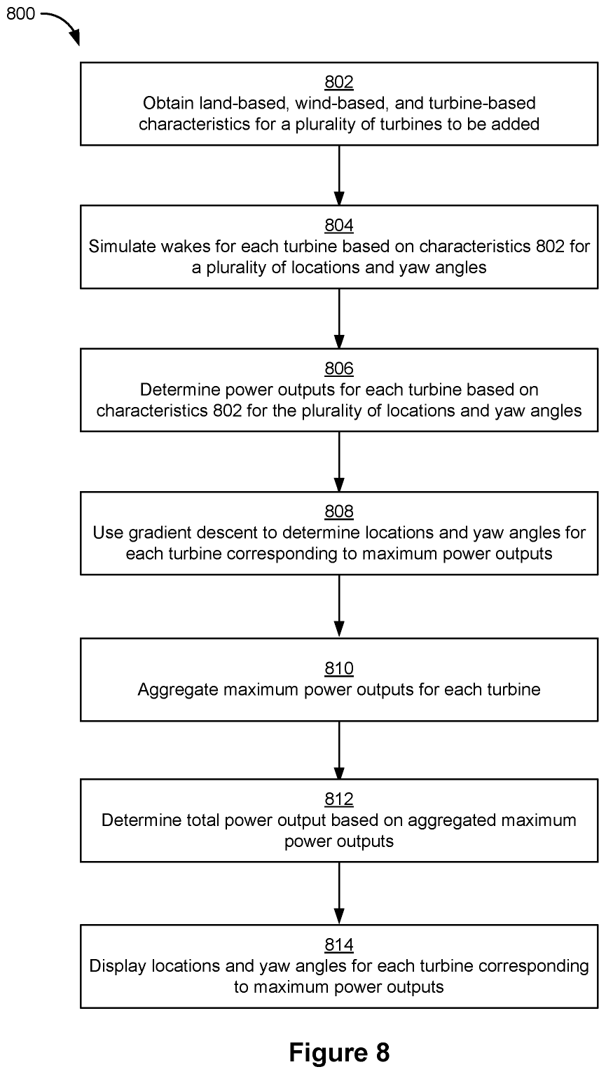

FIG. 8 is a flow diagram of a method 800 of optimizing site planning at a wind farm site using a turbine site planning system (e.g., 110, FIG. 1) in accordance with some implementations. The method 800 may be governed by instructions that are stored in a computer memory or non-transitory computer readable storage medium (e.g., 104, FIG. 1). The instructions may be included in one or more programs stored in the non-transitory computer readable storage medium. When executed by one or more processors (e.g., 102, FIG. 1), the instructions cause a system (e.g., 110, FIG. 1) to perform the process. The non-transitory computer readable storage medium may include one or more solid state storage devices (e.g., Flash memory), magnetic or optical disk storage devices, or other non-volatile memory devices. The instructions may include source code, assembly language code, object code, or any other instruction format that can be interpreted by one or more processors. Some operations in the process may be combined, and the order of some operations may be changed.

The system obtains (802) land-based characteristics of a wind farm site, wind-based characteristics of the wind farm site, a number of a plurality of wind turbines to be added to the wind farm site (in some instances, in addition to existing turbines), and turbine-based characteristics (or data describing the characteristics) for each of the plurality of wind turbines to be added to a wind farm.

Examples of land-based characteristics includes location data (e.g., coordinates that describe the boundary (e.g., 310, FIG. 3) of the wind farm site), terrain data, and elevation data.

Examples of wind-based characteristics (sometimes referred to as environment-based data) include wind velocity, wind direction, a distribution of the wind velocity and wind direction across the wind farm site over time (e.g., over one or more years) (e.g., 304, FIG. 3; 400, FIG. 4), turbulence intensity, temperature, and air density.

Examples of turbine-based characteristics include, for each turbine to be added to the wind farm site, the model, capacity, rotor diameter, hub height, power and thrust curves, nacelle position, yaw angle, and blade pitch angle (e.g., FIG. 2).

For each wind turbine of the plurality of wind turbines, the system simulates (804) a plurality of wakes at a plurality of locations within the boundary of the wind farm site using a plurality of yaw angles, based on the wind-based characteristics at each of the plurality of locations and the turbine-based characteristics. Stated another way, the system simulates and optimizes the optimal yaw angle for each turbine.

For each wind turbine of the plurality of wind turbines, the system determines (806) a plurality of power outputs based on the plurality of simulated wakes, the wind-based characteristics at each of the plurality of locations, and the turbine-based characteristics. Stated another way, the system simulates and optimizes the optimal location for each turbine.

The system uses a gradient descent algorithm (808) to determine location and yaw angles for each turbine corresponding to maximum power outputs. Specifically, the system determines successive locations of the plurality of locations by applying a gradient descent to the plurality of power outputs (e.g., as described with reference to FIGS. 5A-5C above), and determines a final location and a final yaw angle corresponding to a maximum power output of the plurality of power outputs.

As a result of operations 804 and 806, the system simulates wakes for each turbine and finds optimal yaw angles and power outputs for each turbine. In some implementations, the system may determine individual output scores for each turbine, and use these scores as a basis for choosing which turbines to move (as described above with reference to FIGS. 5A-5C). Stated another way, when a turbine is placed at a particular location, then the system runs a simulation to determine the optimal yaw angles for different wind conditions and the power output for the turbine.

The system aggregates (810) the results for each turbine (yaw angles and power outputs) across the wind distribution at the wind farm site. Stated another way, the system aggregates maximum power outputs corresponding to each wind turbine of the plurality of wind turbines. In some implementations, the system aggregates the maximum power outputs over time (e.g., over the course of a year or longer) to determine the layout corresponding to the greater maximum power output over time.

The system determines (812) a total power output for the wind farm site based on the aggregated maximum power outputs (e.g., by adding or otherwise combining the individual power output results). The system then displays or causes to be displayed (814) (i) the final location and the final yaw angle corresponding to each wind turbine of the plurality of wind turbines (e.g., FIG. 5C), and (ii) the total power output for the wind farm site.

In some implementations, the system applies the gradient descent to the plurality of power inputs by determining a differentiable function of the plurality of power outputs, and applying the gradient descent to the differentiable function to determine the final location and the final yaw angle corresponding to the maximum power output (as described above with reference to FIGS. 5A-5C).

In some implementations, for each wind turbine (e.g., 502, FIG. 5A) of the plurality of wind turbines, the system scores each successive location of the plurality of locations (e.g., 502 in FIGS. 5A-5C), based on the plurality of power outputs; and determines the maximum power output based on the scoring.

In some implementations, when determining successive locations of the plurality of locations for each turbine, the system maintains a minimum distance between neighboring wind turbines.

In some implementations, when determining successive locations of the plurality of locations for each turbine, the system selects locations relative to neighboring wind turbines that satisfy one or more wake steering requirements. Stated another way, the simulation may perform wake steering upon simulating the wakes and account for the wake steering when determining successive turbine positions.

In some implementations, the system simulates the plurality of wakes and/or the plurality of power outputs at the plurality of locations by applying a machine learning model to (i) the wind-based characteristics at each of the plurality of locations and (ii) the turbine-based characteristics for each turbine.

For implementations in which the wind farm site is an on-shore site or a fixed off-shore site, each wind turbine of the plurality of wind turbines is configured to be located at a respective fixed location (e.g., 502, FIGS. 5A-5C) within the boundary of the wind farm site, and the system therefore determines successive fixed turbine locations of the plurality of locations.

For implementations in which the wind farm site is a floating off-shore site, each wind turbine of the plurality of wind turbines is configured to be located at a respective variable location about a central anchor location (e.g., 606, 616) within the boundary of the wind farm site, and the system therefore determines successive locations of the plurality of locations by sampling distributions of the variable locations about successive central anchor locations and applying the gradient descent algorithm to the sampled distributions of variable locations (e.g., as described above with reference to FIGS. 7A-7B).

In some implementations, the system may validate the location, yaw angle, and/or power output results for each turbine by using a computational fluid dynamics (CFD) simulation. While a CFD simulation would be inefficient in determining turbine locations, the CFD simulation could be useful in validating the turbine locations that were determined as described above.

### Wake and Power Output Simulation

In some implementations, the system simulates wakes and power outputs (e.g., in operation 704 and/or 804) using one or more of the techniques described in King et al., Controls-Oriented Model for Secondary Effects of Wake Steering, 2020 (pages 3-7); Gocmen et al., Wind turbine wake models developed at the technical university of Denmark: A review, 2016 (pages 753-762); and Mckay et al., Turbine Wake Dynamics, 2012 (pages 65-82), each of which is hereby incorporated by reference in its entirety. In one example, the Gauss-Curl Hybrid (GCH) model as described in King et al., or a model based on the GCH model, may be used to simulate wakes and power outputs for each turbine.

In some implementations, wake steering may be modeled as part of the simulations in operation 704 and/or 804 (e.g., as in King et al.). Wake steering optimizes the locations and yaw angles of each turbine such that the negative effect of wakes on power output is minimized.

In one wind turbine wake model, referred to as a velocity deficit model, the velocity deficit behind a turbine may be characterized in normal operation in a wind farm. The velocity deficit of the wake may be computed by assuming a Gaussian wake, which may be based on a self-similarity theory used in free shear flows. An analytical expression for the three-dimensional velocity, uG, behind a turbine may be computed as:

$$\frac{{u}_{G} ( x , y , z )}{{U}_{∞}} = 1 - {Ce}^{- {( y - δ )}^{2} / 2 {σ}_{y}^{2} - {( z - {z}_{h} )}^{2} / 2 {σ}^{2}} , \\ C = 1 - \sqrt{1 - \frac{( {σ}_{y 0} {σ}_{z 0} ) {M}_{0}}{{σ}_{y} {σ}_{z}}} \\ {M}_{0} = {C}_{0} ( 2 - {C}_{0} ) \\ {C}_{0} = 1 - \sqrt{1 - {C}_{T}}$$

where C is the velocity deficit at the wake center, U_{∞} is the freestream velocity, δ is the wake deflection, zₕ is the hub height of the turbine, σ_{y} defines the wake width in the y direction, and σ_{z} defines the wake width in the z direction. Each of these parameters is defined with respect to each turbine. The subscript “0” refers to the initial values at the start of the far wake, which is dependent on ambient turbulence intensity, I₀, and the thrust coefficient, CT.

The velocity distributions σ_{z} and σ_{y} are defined as:

$$\frac{{σ}_{z}}{D} = {k}_{z} \frac{( x - {x}_{0} )}{D} + \frac{{σ}_{z 0}}{D} where \frac{{σ}_{x 0}}{D} = \frac{1}{2} \sqrt{\frac{{u}_{R}}{{U}_{∞} + {u}_{0}}} \\ \frac{{σ}_{y}}{D} = {k}_{y} \frac{( x - {x}_{0} )}{D} + \frac{{σ}_{y 0}}{D} where \frac{{σ}_{y 0}}{D} = \frac{{σ}_{x 0}}{D} cos γ$$

where D is the rotor diameter, u_{R} is the velocity at the rotor, u₀ is the velocity behind the rotor, k_{y} defines the wake expansion in the lateral direction, and k_{z} defines the wake expansion in the vertical direction. In some implementations, k_{y} and k_{z} may be set to be equal and the wake expands at the same rate in the lateral and vertical directions. The wakes may be combined using the traditional sum of squares method, or any other suitable method.

In addition to the velocity deficit, a wake deflection model may be used to describe the turbine behavior in yaw misaligned conditions, which occur when performing wake steering. The angle of wake deflection θ due to yaw misalignment, and the initial wake deflection δ₀ are defined as:

$$θ \approx \frac{0.3 γ}{cos γ} ( 1 - \sqrt{1 - {C}_{T} cos γ} ) \\ {δ}_{0} = {x}_{0} tan θ$$

where x₀ indicates the length of the near wake, which is typically on the order of 3 rotor diameters.

The total deflection of the wake due to yaw misalignment is defined as:

$$δ = {δ}_{0} + \frac{γ {E}_{0}}{5.2} \sqrt{\frac{{σ}_{y 0} {σ}_{z 0}}{{k}_{y} {k}_{z} {M}_{0}}} ln [ \frac{( 1.6 + \sqrt{{M}_{0}} ) ( 1.6 \sqrt{\frac{σ \text{?} σ \text{?}}{σ \text{?} σ \text{?}}} - \sqrt{{M}_{0}} )}{( 1.6 - \sqrt{{M}_{0}} ) ( 1.6 \sqrt{\frac{{σ}_{y} {σ}_{x}}{σ \text{?} σ \text{?}}} + \sqrt{{M}_{0}} )} ] \\ where {E}_{0} = {C}_{0}^{2} - 3 {e}^{\frac{1}{12}} {C}_{0} + 3 e \text{?} .$$

$$\text{?} \text{indicates text missing or illegible when filed}$$

In another wind turbine wake model, spanwise and vertical velocity components may be used for modeling the effects of wake steering. These velocity components can be computed based on wake rotation and yaw misalignment. Wake rotation may be included by modeling the effects of rotation using a Lamb-Oseen vortex to de-singularize the behavior near the center of the rotor. The circulation strength for the wake rotation vortex is now:

$$Γ \text{?} = \frac{π ( a - {a}^{2} ) {U}_{∞} D}{λ}$$

$$\text{?} \text{indicates text missing or illegible when filed}$$

where α is the axial induction factor of the turbine and λ is the tip-speed ratio.

The vertical and spanwise velocities can then be computed using the strength of the vortex, Γ, by:

$${V}_{wake rotation} = \frac{Γ \text{?} ( y - {y}_{0} )}{2 π ( {( y - {y}_{0} )}^{2} + {( z - {z}_{h} )}^{2} )} ( 1 - e \text{?} ) \\ {W}_{wake rotation} = \frac{Γ \text{?} ( z - {z}_{h} )}{2 π ( {( y - {y}_{0} )}^{2} + {( z - {z}_{h} )}^{2} )} ( 1 - e \text{?} )$$

$$\text{?} \text{indicates text missing or illegible when filed}$$

where y₀ is the spanwise position of the turbine, e represents the size of the vortex core. In some implementations, ∈=0.3D.

In addition to the wake rotation, when a turbine is operating in yaw-misaligned conditions, the turbine generates counterrotating vortices that are released at the top and the bottom of the rotor. This is an approximation to the counter-rotating vortices in that this model approximates the vortices as one at the top and bottom of the rotor rather than a collection of smaller vortices. The strength of these vortices can be computed as, Γ, and is a function of the yaw angle, γ:

$$Γ ( γ ) = \frac{π}{8} ρ {DU}_{∞} {C}_{T} sin γ cos {γ}^{2}$$

where ρ is the air density.

As is done with wake rotation, the spanwise V and vertical W velocity components can be computed based on the strength of the wake rotation and yaw misalignment of a turbine. The spanwise velocity can be computed as:

$${V}_{top} = \frac{Γ ( y - {y}_{0} )}{2 π ( {( y - {y}_{0} )}^{2} + {( z - ( {z}_{h} + R ) )}^{2} )} ( 1 - e \text{?} ) \\ {V}_{bottom} = \frac{Γ ( y - {y}_{0} )}{2 π ( {( y - {y}_{0} )}^{2} + {( z - ( {z}_{h} - R ) )}^{2} )} ( 1 - e \text{?} )$$

$$\text{?} \text{indicates text missing or illegible when filed}$$

where R is the turbine radius and Vₜₒₚ and V_{bottom} are the spanwise velocities generated at the top and bottom of the rotor. The spanwise and vertical velocities may be combined using a linear combination at downstream turbines. The total spanwise velocity is:

$${V}_{wake} = {V}_{top} + {V}_{bottom} + {V}_{wake rotation}$$

Similarly, the vertical velocity can be written as:

$${W}_{top} = \frac{{Γ}_{top} ( z - ( {z}_{h} + R ) )}{2 π ( {( y - {y}_{0} )}^{2} + {( z - ( {z}_{h} + R ) )}^{2} )} ( 1 - e \text{?} ) \\ {W}_{bottom} = \frac{{Γ}_{bottom} ( z - ( {z}_{h} - R ) )}{2 π ( {( y - {y}_{0} )}^{2} + {( z - ( {z}_{h} - R ) )}^{2} )} ( 1 - e \text{?} )$$

$$\text{?} \text{indicates text missing or illegible when filed}$$

The total vertical velocity can be computed as:

$${W}_{wake} = {W}_{top} = {W}_{bottom} + {W}_{wake rotation}$$

Ground effects may be included by adding mirrored vortices below the ground.

Finally, the vortices generated by the turbines decay as they move downstream. The dissipation of these vortices can be computed as:

$$V = {V}_{wake} ( \frac{{ϵ}^{2}}{4 {v}_{T} \frac{( x - {x}_{0} )}{{U}_{∞}} + {ϵ}^{2}} ) \\ W = {W}_{wake} ( \frac{{ϵ}^{2}}{4 {v}_{T} \frac{( x - {x}_{0} )}{{U}_{∞}} + {ϵ}^{2}} )$$

where ν_{T} is the turbulent viscosity, which is defined using a mixing length model:

$${v}_{T} = {l}_{m}^{2} \vert \frac{\partial U}{\partial z} \vert \\ where {l}_{m} = \frac{xz}{1 + xz / λ \text{?}} κ = 0.41 , and {λ}_{T} = D / 8.$$

$$\text{?} \text{indicates text missing or illegible when filed}$$

λ_{T} is the value of the mixing length in the free atmosphere.

### Miscellaneous

Reference have been made in detail to various implementations, examples of which are illustrated in the accompanying drawings. In the above detailed description, numerous specific details are set forth in order to provide a thorough understanding of the invention and the described implementations. However, the invention may be practiced without these specific details. In other instances, well-known methods, procedures, components, and circuits have not been described in detail so as not to unnecessarily obscure aspects of the implementations.

It will be understood that, although the terms “first,” “second,” etc. may be used herein to describe various elements, these elements should not be limited by these terms. These terms are only used to distinguish one element from another. For example, a first device could be termed a second device, and, similarly, a second device could be termed a first device, without changing the meaning of the description, so long as all occurrences of the first device are renamed consistently and all occurrences of the second device are renamed consistently. The first device and the second device are both devices, but they are not the same device.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific implementations. However, the illustrative discussions above are not intended to be exhaustive or to limit the invention to the precise forms disclosed. Many modifications and variations are possible in view of the above teachings. The implementations were chosen and described in order to best explain the principles of the invention and its practical applications, to thereby enable others skilled in the art to best utilize the invention and various implementations with various modifications as are suited to the particular use contemplated.

What is claimed is:

1. A wind farm site planning optimization system, comprising:
one or more processors; and
memory storing one or more programs for execution by the one or more processors, the one or more programs comprising instructions for:
obtaining land-based characteristics of a wind farm site, including data describing a boundary of the wind farm site;
obtaining wind-based characteristics of the wind farm site, including a distribution of wind velocity and wind direction across the wind farm site over time;
obtaining a number of a plurality of wind turbines to be added to the wind farm site; and
obtaining turbine-based characteristics for each of the plurality of wind turbines, including two or more of model, capacity, rotor diameter, hub height, power curve, thrust curve, or nacelle position;
for each wind turbine of the plurality of wind turbines:
simulating a plurality of wakes at a plurality of locations within the boundary of the wind farm site using a plurality of yaw angles, based on the wind-based characteristics at each of the plurality of locations and the turbine-based characteristics;
determining a plurality of power outputs based on the plurality of simulated wakes, the wind-based characteristics at each of the plurality of locations, and the turbine-based characteristics;
determining successive locations of the plurality of locations by applying a gradient descent to the plurality of power outputs;
determining a final location and a final yaw angle corresponding to a maximum power output of the plurality of power outputs;
aggregating maximum power outputs corresponding to each wind turbine of the plurality of wind turbines;
determining a total power output for the wind farm site based on the aggregated maximum power outputs; and
displaying (i) the final location and the final yaw angle corresponding to each wind turbine of the plurality of wind turbines, and (ii) the total power output for the wind farm site.

2. The electronic computer system of claim 1, wherein the instructions for applying the gradient descent to the plurality of power inputs include instructions for:
determining a differentiable function of the plurality of power outputs; and
applying the gradient descent to the differentiable function to determine the final location and the final yaw angle corresponding to the maximum power output.

3. The electronic computer system of claim 1, wherein the one or more programs further comprise instructions for:
for each wind turbine of the plurality of wind turbines, scoring each successive location of the plurality of locations based on the plurality of power outputs; and
determining the maximum power output based on the scoring.

4. The electronic computer system of claim 1, wherein the instructions for determining successive locations of the plurality of locations include instructions for maintaining a minimum distance between neighboring wind turbines.

5. The electronic computer system of claim 1, wherein the instructions for determining successive locations of the plurality of locations include instructions for selecting locations relative to neighboring wind turbines that satisfy one or more wake steering requirements.

6. The electronic computer system of claim 1, wherein the instructions for simulating the plurality of wakes at the plurality of locations include instructions for applying a machine learning model to the wind-based characteristics at each of the plurality of locations and the turbine-based characteristics.

7. The electronic computer system of claim 1, wherein:
the wind farm site is an on-shore site or a fixed off-shore site;
each wind turbine of the plurality of wind turbines is configured to be located at a respective fixed location within the boundary of the wind farm site; and
the instructions for determining successive locations of the plurality of locations include instructions for determining fixed locations.

8. The electronic computer system of claim 1, wherein the wind farm site is a floating off-shore site.

9. The electronic computer system of claim 8, wherein each wind turbine of the plurality of wind turbines is configured to be located at a respective variable location about a central anchor location within the boundary of the wind farm site.

10. The electronic computer system of claim 9, wherein the instructions for determining successive locations of the plurality of locations include instructions for sampling distributions of the variable locations about successive central anchor locations.

11. A floating off-shore wind farm site planning optimization system, comprising:
one or more processors; and
memory storing one or more programs for execution by the one or more processors, the one or more programs comprising instructions for:
obtaining area-based characteristics of a wind farm site, including data describing a boundary of the wind farm site, wherein the wind farm site is a floating off-shore site;
obtaining wind-based characteristics of the wind farm site, including a distribution of wind velocity and wind direction across the wind farm site over time;
obtaining a number of a plurality of wind turbines to be added to the wind farm site, wherein each wind turbine of the plurality of wind turbines is configured to be located at a respective variable location about a central anchor location within the boundary of the wind farm site; and
obtaining turbine-based characteristics for each of the plurality of wind turbines, including two or more of model, capacity, rotor diameter, hub height, power curve, thrust curve, or nacelle position;
for each wind turbine of the plurality of wind turbines:
simulating a plurality of wakes at a plurality of locations within the boundary of the wind farm site using a plurality of yaw angles, based on the wind-based characteristics at each of the plurality of locations and the turbine-based characteristics;
determining a plurality of power outputs based on the plurality of simulated wakes, the wind-based characteristics at each of the plurality of locations, and the turbine-based characteristics;
determining successive locations of the plurality of locations by sampling distributions of the variable locations about successive central anchor locations;
determining a final location and a final yaw angle corresponding to a maximum power output of the plurality of power outputs;
aggregating maximum power outputs corresponding to each wind turbine of the plurality of wind turbines;
determining a total power output for the wind farm site based on the aggregated maximum power outputs; and
displaying (i) the final location and the final yaw angle corresponding to each wind turbine of the plurality of wind turbines, and (ii) the total power output for the wind farm site.

12. The electronic computer system of claim 11, wherein the instructions for determining successive locations of the plurality of locations include instructions for applying a gradient descent to the plurality of power outputs.

13. The electronic computer system of claim 12, wherein the instructions for applying the gradient descent to the plurality of power inputs include instructions for:
determining a differentiable function of the plurality of power outputs; and
applying the gradient descent to the differentiable function to determine the final location and the final yaw angle corresponding to the maximum power output.

14. The electronic computer system of claim 11, wherein the one or more programs further comprise instructions for:
for each wind turbine of the plurality of wind turbines, scoring each successive location of the plurality of locations based on the plurality of power outputs; and
determining the maximum power output based on the scoring.

15. The electronic computer system of claim 11, wherein the instructions for determining successive locations of the plurality of locations include instructions for maintaining a minimum distance between neighboring wind turbines.

16. The electronic computer system of claim 15, wherein the minimum distance accounts for variable movement of wind turbines about their respective central anchor locations.

17. The electronic computer system of claim 11, wherein the instructions for determining successive locations of the plurality of locations include instructions for selecting locations relative to neighboring wind turbines that satisfy one or more wake steering requirements.

18. The electronic computer system of claim 11, wherein the instructions for simulating the plurality of wakes at the plurality of locations include instructions for applying a machine learning model to the wind-based characteristics at each of the plurality of locations and the turbine-based characteristics.
